(19) United States
(12) Patent Application Publication
(10) Pub. No.: US 2024/0086877 A1
(43) Pub. Date: Mar. 14, 2024

(54) SYSTEM TO INITIATE FUND TRANSFERS USING UNIFORM RESOURCE LOCATOR

(71) Applicant: AMERICAN EXPRESS KABBAGE INC., Atlanta, GA (US)

(72) Inventors: Robert Frohwein, Atlanta, GA (US); Troy Deus, Atlanta, GA (US)

(21) Appl. No.: 18/518,283

(22) Filed: Nov. 22, 2023

Related U.S. Application Data
(63) Continuation of application No. 16/292,517, filed on Mar. 5, 2019, now abandoned.
(60) Provisional application No. 62/638,913, filed on Mar. 5, 2018.

(51) Int. Cl. G06Q 20/10; G06F 40/174

(52) U.S. Cl. CPC G06Q 20/102; G06F 40/174

(57) ABSTRACT

Disclosed are various embodiments for initiating fund transfers using links. Various embodiments can send an invoice to an invoicee device of an invoicee, such that the invoice comprises a link. Embodiments can handle the request for the content at the link's location and then send an invoice payment detail web page to the invoicee device that includes at least an amount input field to capture an invoice payment amount. Embodiments can then receive an invoice payment detail response that includes at least the invoice payment amount and then initiate a payment from a provider account to an invoicer account, the provider account being held by a provider and the invoicer account being held by the invoicer.

### CROSS-REFERENCE TO RELATED APPLICATIONS

This application claims priority to co-pending U.S. patent application entitled, “SYSTEM TO INITIATE FUND TRANSFERS USING UNIFORM RESOURCE LOCATOR,” having application Ser. No. 16/292,517, filed Mar. 5, 2019, which claims benefit of U.S. provisional application entitled, “SYSTEM TO INITIATE FUND TRANSFERS USING UNIFORM RESOURCE LOCATOR,” having application No. 62/638,913, filed Mar. 5, 2018, each of which is incorporated by reference in its entirety.

### BACKGROUND OF THE INVENTION

### Field of the Invention

The present general inventive concept is directed to a method, apparatus, and computer readable storage medium directed to a method, system, and computer readable storage medium to enable parties who send invoices (invoicer) to generate a link which can be pasted on the invoice so that the recipient (invoice) can remit funds utilizing the link.

### Description of the Related Art

U.S. Pat. No. 7,983,951, entitled “Apparatus to provide liquid funds in the online auction and marketplace environment” describes a system in which a cash provider can evaluate a business and determine whether to extend credit to the business based on a numerical evaluation of characteristics of the business.

What is needed is a streamlined way for a business to apply for and utilize a credit line in order to easily pay their invoices.

### SUMMARY OF THE INVENTION

It is an aspect of the present invention to provide an improved payment system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of initiating an invoicer, according to an embodiment;

FIG. 2 is a sample invoicer application to enable creation of invoice links, according to an embodiment;

FIG. 3 is a flowchart illustrating an exemplary method of generating and transmitting an invoice with an invoice link, according to an embodiment;

FIG. 4 is a flowchart illustrating an exemplary method of paying an invoice through a cash provider, according to an embodiment;

FIG. 5 is a network diagram illustrating participants to the system, according to an embodiment;

FIG. 6 is a sample invoice with an invoice link pasted into it, according to an embodiment;

FIG. 7 is a sample invoice application once the invoice link is clicked for the first time, according to an embodiment;

FIG. 8 is an exemplary web page illustrating how an invoicee can initiate a payment to the invoicer utilizing the cash provider, according to an embodiment;

FIG. 9 is an exemplary web page which can appear after an invoicee visits an invoice link after the invoicee already has been approved for an account with the cash provider, according to an embodiment;

FIG. 10 is a block diagram illustrating an example of computer hardware to implement a digital computer, according to an embodiment;

FIG. 11 is a flowchart illustrating an exemplary method of automatically filling in fields for a credit application, according to an embodiment; and

FIG. 12 is a block diagram illustrating an example of computer hardware which can be used to implement any computer utilized herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

A company that sends an invoice to another party is referred to as an invoicer. The party that receives the invoice is referred to as an invoice. A party that can pay the invoice to the invoicer on behalf of the invoicee is referred to as the cash provider.

When an invoicer invoices an invoicee, the invoicee typically doesn't not pay immediately and can (in some cases) take a long time to pay the invoice. Sometimes, the invoicee would take a very long time to pay, or even not at all. It would be ideal to the invoicer if the invoicer could get paid quickly upon invoicing an invoice. It would also be ideal to the invoicee if the invoicee had some way to easily pay the invoice using a credit line so they wouldn't be required to pay the invoice immediately out of their own funds. An embodiment of the present inventive concept enables the invoicer to post an invoice link on an invoice sent to the invoicee in which the invoicee can click and make payment via a credit line (and apply for one if necessary) to the invoicer. This creates a streamlined system which benefits both the invoicer and the invoicee.

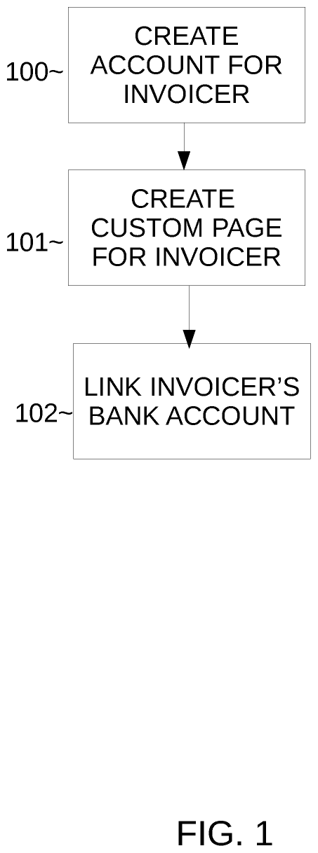

FIG. 1 is a flowchart illustrating an exemplary method of initiating an invoicer, according to an embodiment. An invoicer would typically need to set up an account with a cash provider in order for the cash provider to be able to effectuate the cash transfers described herein.

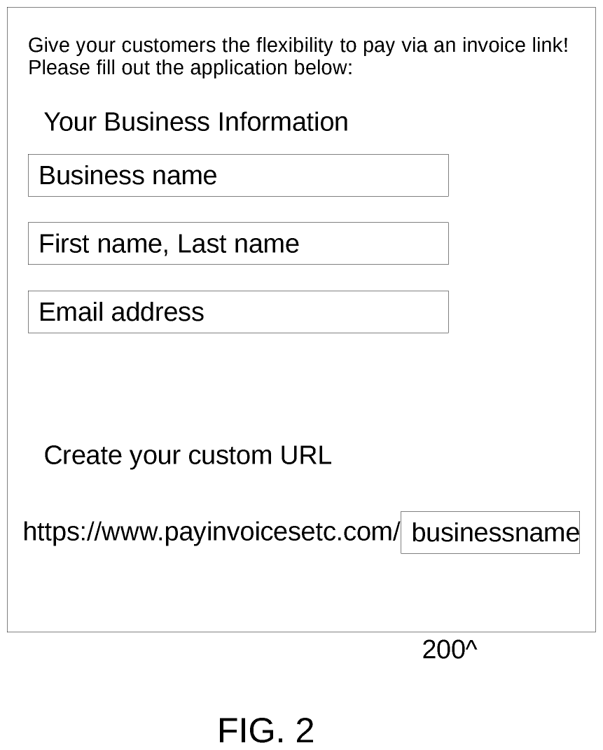

In operation 100, the invoicer fills out a web form. The invoicer initiates an account application on a cash provider server (e.g., by visiting a web site, clicking a link in an email, etc.) maintained by the cash provider. The web site would provide a web form that the invoicer would fill out. The web form (such as that illustrated in FIG. 2) would ask for company information like the company name, company income, login name, password, etc. The invoicer's bank account information will also be prompted for so that the invoicer can link their bank account to the cash provider (which will be used to electronically transfer funds to the invoicer whenever an invoicee “pays” an invoice using the invoice link as described herein). As an alternative, the invoicer can decline to link their bank account and simply opt to receive checks from the cash provider who will be paying invoices on an invoicee's behalf.

Note that the invoicer (depending on the cash provider's preferences) may or may not need to pass a credit check before being granted an account. In order to utilize some invoicing methods described herein (including having a cash provider extend credit to pay an invoice), the invoicee (not the invoicer) is typically on the hook for payment of the invoice. Nevertheless, the cash provider may require any potential invoicer to have their company under an initial credit check (or other evaluation of the company) in order to ensure they are a reputable and trustworthy business (which could help avoid fraud).

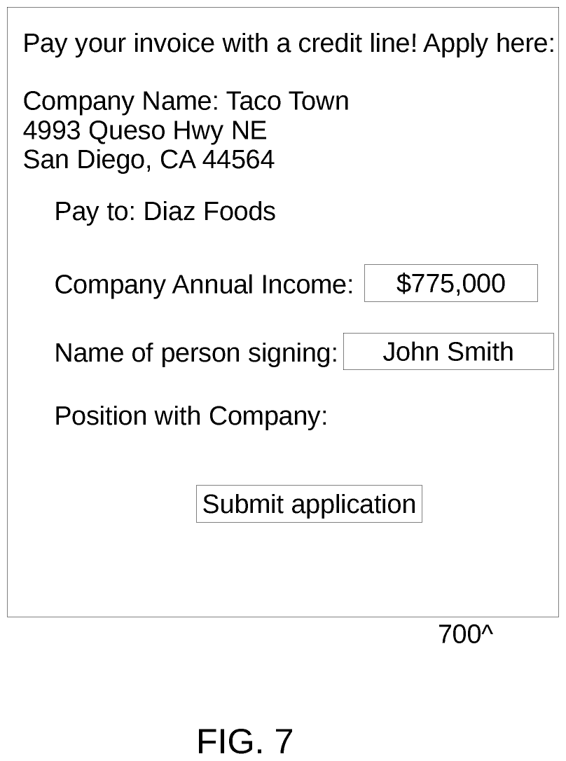

From operation 100, the method proceeds to operation 101, which creates a custom web page for the invoicer. This page is displayed whenever a customer who is invoiced clicks the link on their invoice. A page is stored on a server maintained by the cash provider. This page can look like, for example, what is shown in FIG. 7. The page can have customized images, fields, etc., which are completely customizable by the invoicer. In a further embodiment, instead of using a custom web page, a generic landing page can be utilized which would apply for all customers and/or invoices, and the customer can identify the invoice to be processed.

From operation 101, the method proceeds to operation 102, which links the invoicer's bank account to the cash provider. In this way, whenever an invoicee utilizes the system to pay an invoicer's invoice using the cash provider, the cash provider would immediately deposit money into the invoicer's provided bank account. For example, the invoicer would type in their routing number and account number so that the cash provider server can store this information and set up this bank account in the system for immediate incoming transfers.

FIG. 2 is a sample invoicer application to enable creation of invoice links, according to an embodiment.

The application illustrated in FIG. 2 is one example of how an invoicer can set up an account with the cash provider. The invoicer can fill out the fields such as business name, name of contact person, email address, physical address, bank account information (e.g., routing and account numbers), etc. The invoicer can also choose their custom URL that would be pasted into an invoice so that the invoicee can cut and paste it into their browser to pay it (e.g., “www.payinvoicesetc.com/businessname”) where the domain name would always be constant across different invoicers but the text following the virgule could be customized by each invoicer (assuming the chosen text has not already been taken).

The invoicer would also provide its bank account information (e.g., routing number, account number, etc.) so that payments can be automatically deposited into the invoicer's bank account.

Once the application is completed, the invoicer can submit the application to the cash provider server so that the cash provider server can make an automatic determination as to whether to approve the account for the invoicer. The data the invoicer has entered can be checked for things like fraud, consistency, etc. A check regarding creditworthiness of the invoicer can also optionally be performed.

Once approved, the invoicer now has a custom link that can be used on its invoices. Clicking this link (by the invoicee) would bring the invoicer's custom web page up to the invoicee (see FIG. 7). In a further embodiment, each invoicer can set up multiple such pages (each with its own unique link), one for each individual invoice. As such, each invoicee can go to a custom page which can display their company name (i.e. the invoicee's), and any particular information known about the invoicee.

In a further embodiment, instead of a custom URL, the link (URL) can be a generic link which leads to a generic landing page in which the invoicee can then fill in fields to identify the invoice to be paid (e.g., invoice number, invoicee name, etc.)

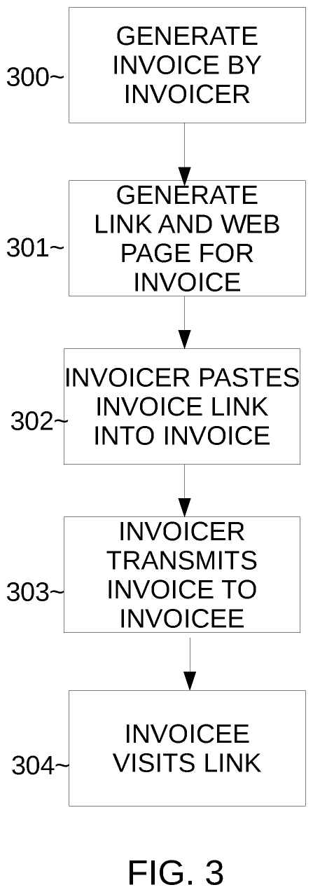

FIG. 3 is a flowchart illustrating an exemplary method of generating and transmitting an invoice with an invoice link, according to an embodiment.

The method can begin with operation 300, which generates an invoice by the invoicer. This can be done as known in the art, for example by using any off the shelf accounting package (such as QUICKBOOKS®, etc.)

From operation 300, the method proceeds to operation 301, in which the invoicer generates an invoice link which will get pasted onto the invoice. In one embodiment, the invoice link will be the same for all invoicees that this invoicer will invoice. That link will open a page wherein the invoicee can log in by typing their company name, password, etc. so that they can then pay the invoice using the cash provider. In another embodiment, the invoice link will be different for each invoicee. For example, if company A is the invoicer and company A invoices company B and company C, then company A would have a link for all invoices for company A and another link for all invoices for company B. In this way, when the link is put into a browser, a dedicated web page will open that goes to a page targeted for that particular company (invoicee). Thus, the web page would already know the company that is the invoicee and this company's name can appear on the web site along with whatever information is targeted to this invoicee (e.g., the invoicee's remaining credit line, amount due, etc.) In a further embodiment, the invoice link will be different for each different invoice generated. The invoicer can generate a unique invoice link for each invoice generated. Thus, when the invoicee goes to this link, the page that opens will know the company name of the invoicee as well as the amount of the particular invoice. So a message can be displayed such as, “welcome ACME. Do you wish to pay invoice #123 for $95?” In this embodiment, the invoicee would not have to type the amount of the particular invoice since the web page would already know it by virtue of the unique link for each invoice.

From operation 301, the method proceeds to operation 302, in which the invoicer pastes the invoice link into the invoice. This can be done, for example, by manually “cutting and pasting” the invoice link (which can be generated by the accounting package or by a separate system maintained by the cash provider (or other party) on the invoice itself before the invoice is transmitted (electronically and/or physically) to the invoicee. In another embodiment, the accounting package can both generate the invoice link and automatically place it into the invoice before the invoice is transmitted. By generating each invoice link, a new web page associated for that invoice link is also generated (if it does not already exist).

From operation 302, the method proceeds to operation 303, wherein the invoice transmits the invoice link to the invoicee. The invoice can be transmitted electronically (e.g., via email or other electronic invoicing system) or physically (by mailing the invoice in the physical mail).

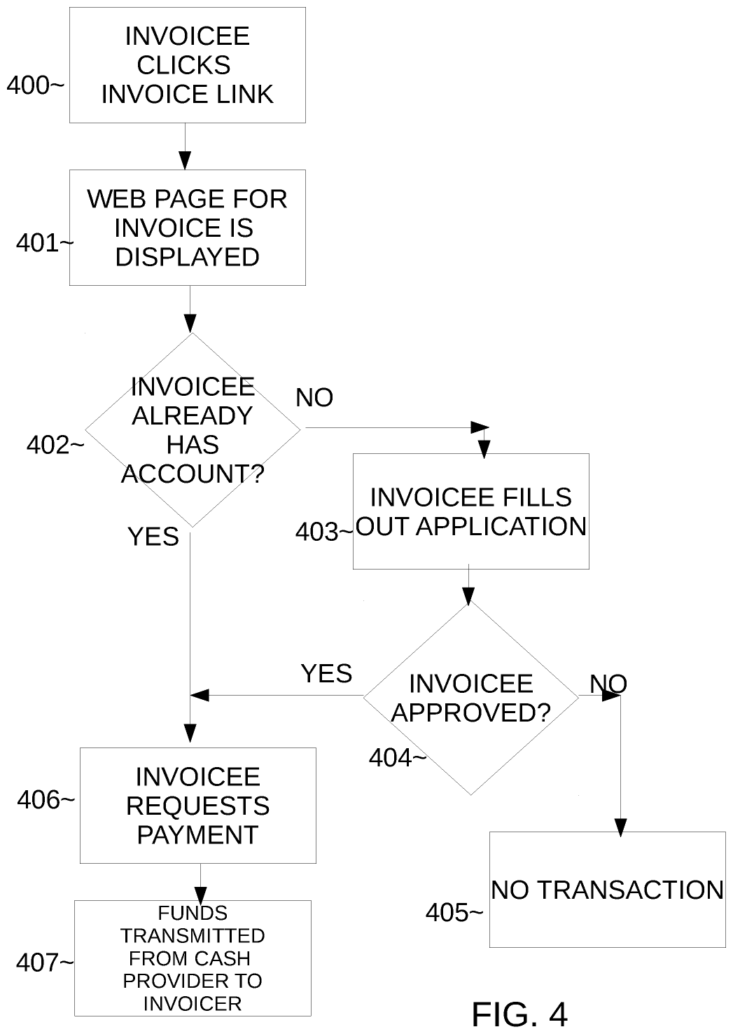

From operation 303, the method proceeds to operation 304, wherein the invoicee then visits the invoice link that was pasted into the invoice. Of course, the invoicee is not required to visit this link and can simply pay the invoice using another method (e.g., by mailing a check). If the invoicee visits the link (by cutting and pasting the invoice link into a browser, or by clicking the invoice link itself on an electronic version of the invoice) then the invoicee's browser will open a page which will enable the invoicee to pay the invoice using a credit line administered by the cash provider. This operation is discussed in more detail in FIG. 4.

FIG. 4 is a flowchart illustrating an exemplary method of paying an invoice through a cash provider, according to an embodiment.

In operation 400, the invoicee clicks the link on the invoice. This can also be accomplished by the invoicee copying and pasting the link into a browser.

From operation 400, the method proceeds to operation 401, wherein the web page that is associated with the invoice link (form operation 400) is displayed on the invoicee's computer. This can be done as known in the art.

From operation 401, the method proceeds to operation 402, which determines whether the invoicee already has an account with the cash provider. This can be done in a number of ways, for example if the invoice link is dedicated for this particular invoicee then the system would already know if the invoicee has an account with the cash provider. The web page can also prompt for a login name and password so that the invoicee can log in if it already has an account and a link can be for those who do not yet have an account.

If in operation 402, the invoicee does not yet have an account, then the method proceeds to operation 403, wherein the invoicee fills out an application (see FIG. 7). The invoicee would provide any information necessary for the cash provider to grant the invoicee a credit line, for example name of business (if it doesn't already know this), physical address, email address, bank account info (account number and routing number), average annual income, type of business, etc.

From operation 403, the method proceeds to operation 404 which makes a determination whether the invoicee is approved for a credit line. This can be accomplished using a variety of methods, for combining a variety of metrics including a credit score (e.g., from one of the credit bureaus), evaluating cash flows for the business (utilizing any financial accounts they provide so financial data can automatically be retrieved), considering the type of business the invoicee is in (e.g., restaurant, construction, etc.). A combination of these factors can be computed (e.g., using a weighted average) to determine a score. If the score meets certain criteria (e.g., higher than a certain number) then the invoicee is approved for a credit line. The amount of the credit line can be based upon the computed score. For more detail on how an evaluation can be conducted on a company to determine whether to extend them credit, see U.S. Pat. No. 7,983,951 which is incorporated by reference herein in its entirety.

If the invoicee is approved for a credit line, the web page would display the terms (received from the cash provider) of the credit line, for example the term (e.g., 6-month, one year, 5 years, etc.) the interest rate (e.g., 2%, 5%, etc.) the penalty for non-payment, etc. The invoicee may also be given an opportunity to select from different options (e.g., a 5% credit line of $1,000 with a six-month term, or a 6% credit line of $2,000 with a one-year term, etc.) The invoicee may also be required to (electronically) sign a contract agreeing to legal terms, such as penalties for non-payment, agreeing to legal remedies for collection of the amounts due, etc. The invoicee will then be able to tap into this credit line periodically, as the invoicee desires. All cash advances against this credit line will be subject to the agreed upon terms.

If in operation 404, the invoicee is not approved for a credit line, then the method proceeds to operation 405, and since the invoicee has not been approved for a credit line there will be no financial transaction conducted. The invoicee will be informed that he was declined for a credit line. Thus, the invoicee will have to pay the invoice using another means (e.g., by sending the invoicer a check).

In operation 402, if the invoicee already has an account (e.g., a credit line with the cash provider), then the method proceeds to operation 406 in which the invoicee requests payment to the invoicer. This can be done by the invoicee entering the amount to pay the invoicer on the web page (typically the amount of the invoice that contained the invoice link). The cash provider will then check to ensure that the invoicee has at least as much credit left as the amount entered. If the invoicee does not have enough credit remaining, then the transaction would be declined and the method would not proceed to operation 407.

Form operation 406, the method would then typically proceed to operation 407 in which the funds (the amount set forth in operation 406) are electronically transmitted from the cash provider to the invoicer. Thus, the invoice that was sent from the invoicer to the invoicee has now been paid simply by the invoicee visiting the invoice link on a browser. Of course, the invoicee's credit line will now be adjusted to reflect the cash advance to the invoicee (e.g., the available credit will be reduced by the amount that was paid to the invoicee).

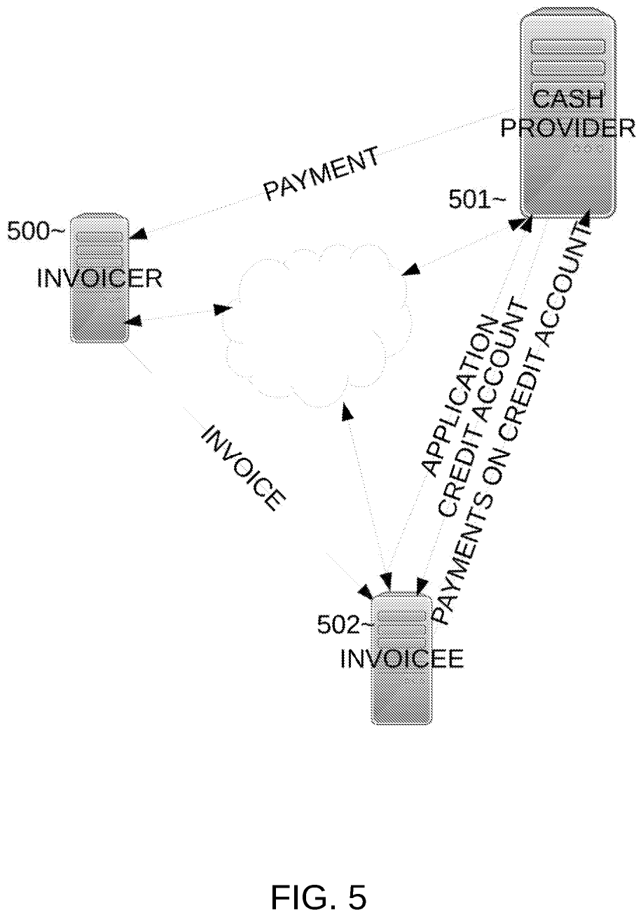

FIG. 5 is a network diagram illustrating participants to the system, according to an embodiment. While servers are shown for the invoicer 500, the invoicee 502, and the cash provider 501, it is intended that the servers represent an electronic presence, database, or other computing system with the functionality to implement their respective functions as described herein, with the respective servers being under the control and administration of the respective party thereof. The flows illustrated in FIG. 5 illustrated one embodiment of the inventive concept (in which the cash provider provides a credit line to the invoicee and pays the invoicer's invoice on behalf of the invoicee), although in other embodiments a different exchange of data and funds would be implemented.

The invoicer 500 is the party who sends an invoice (or a plurality of invoices) to the invoicee 502. The invoice can be sent electronically (e.g., via email, etc.) or physically (e.g., in the mail). The cash provider 501 electronically provides funds to the invoicer 500 and/or the invoicee 502. While FIG. 5 depicts that the funds are transmitted between the parties, in reality funds are sent between bank accounts owned/maintained by the respective parties. In one embodiment, the cash provider server 501 executes programs which can implement (or cause to be implemented) all of the methods described herein (although an external computer may request functionality from the cash provider server 501).

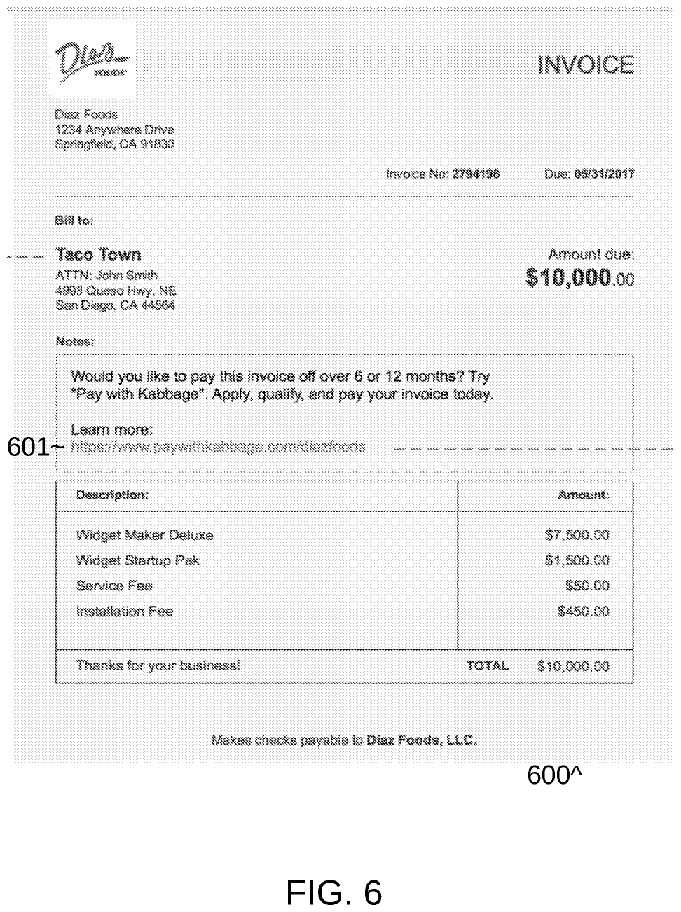

FIG. 6 is a sample invoice with an invoice link pasted into it, according to an embodiment.

In the sample invoice, Diaz Foods is the invoicer (the party sending the invoice) and Taco Town is the invoicee (the party receiving the invoice that is responsible for paying the invoice). Note the invoice link 601 which is embedded (or pasted) into the invoice. The invoicee can then click this link 601 (if the invoice is being displayed on the invoicee's computer) or can cut/paste the link 601 into a browser. Alternatively, the invoicee can also simply type in the text of the link 601 into a browser. Once the link 601 is pasted into a browser, a customized web page will then be displayed (which was set up by the invoicer). The customized web page can be stored and maintained on the invoicer's server, the cash provider, a separate web host, or any other computer. By visiting the link 601, the invoicee can then initiate an electronic payment of this invoice to the invoicer (Diaz Foods) which would come from a credit line administered by the cash provider. Of course, any credit extended by the cash provider to the invoicee would ultimately have to be paid back by the invoicee to the cash provider, along with interest (at terms agreed upon when the credit line was set up).

FIG. 7 is a sample invoice application once the invoice link is visited for the first time, according to an embodiment.

When the invoice link is visited (clicked or pasted into a browser), a web page with a welcome message could appear along with a credit line application. The invoicee (assuming the invoicee wishes to apply for the credit line with the cash provider), and then fill out the application. The application will include fields like company name, annual income, name of person signing, physical address, email address, web site, etc.

In one embodiment the web page could already know some of the fields (e.g., the company name and their address) by virtue of the invoicer generating the invoice link using a system that is input the identity of the invoicee. In another embodiment, the invoicee would have to fill in all of the fields on the application as the web page would not come pre-populated with any fields filled in. When the invoicee has completed filling in the application, the invoicee can click a “submit application” button to initiate processing of the application.

Once submitted, the cash provider server would then receive the application and process the application (as described in operation 404). If the application is not approved then the web site will display a message to this effect to the invoicee and then the invoicee will have to pay the invoice using another means.

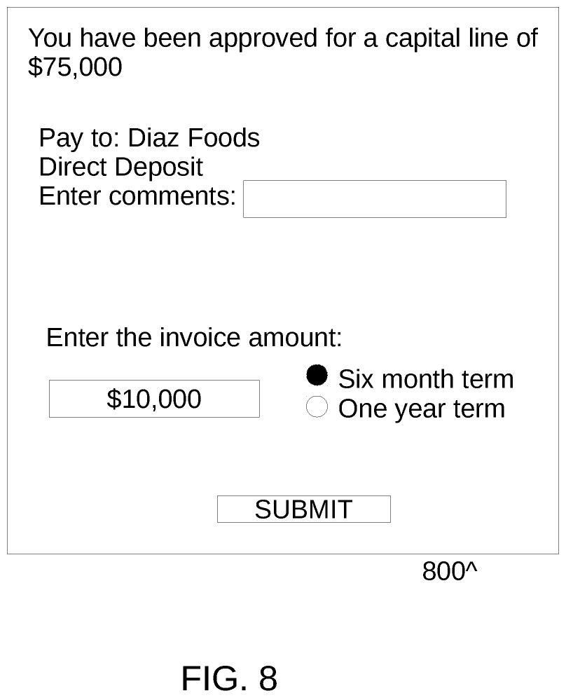

FIG. 8 is an exemplary web page illustrating how an invoicee can initiate a payment to the invoicer utilizing the cash provider, according to an embodiment.

If the application is approved, then a message to that effect can be displayed to the invoicee. Also displayed to the invoicee is an amount of the credit line extended to the invoicee.

The invoicee will now have the opportunity to pay the invoice that had the invoice link by typing in the amount of the invoice, any comments the invoicee has that he/she wants the invoicer to see (e.g., an invoice number being paid), and other parameters the invoicee can decide upon such as the term (e.g., six months or one year).

Once the invoicee clicks “submit” the cash provider will then initiate an electronic transfer of funds from a bank account owned by the cash provider to the bank account owned by the invoicer. The invoicee's credit line will reflect the utilization of an amount of credit equal to the amount being paid.

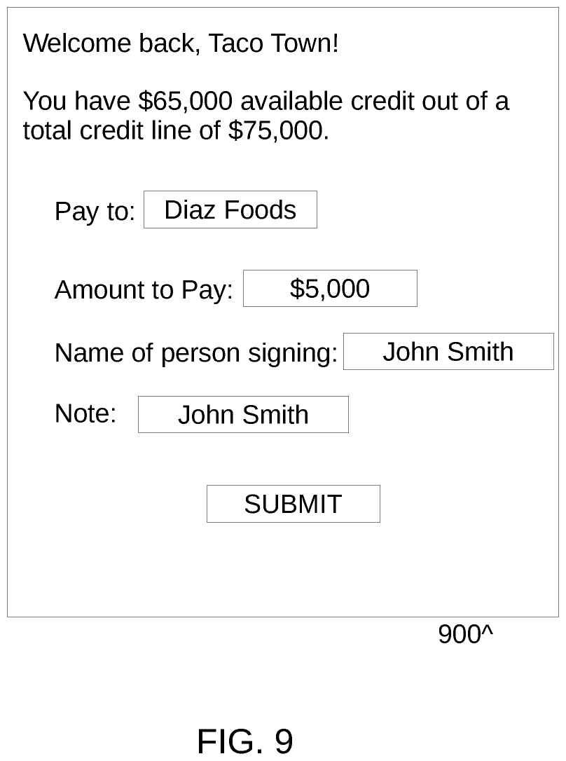

FIG. 9 is an exemplary web page which can appear after an invoicee visits an invoice link after the invoicee already has been approved for an account with the cash provider, according to an embodiment.

When an invoicee has already set up a credit line with the cash provider (for example, by visiting a previous invoice link from a prior invoice) then it is not necessary for the invoicee to reapply for the credit line again. In fact, the invoicee may already have used up part (or all) of its credit line. When the invoicee who already has a credit line with the cash provider visits an invoice link then a “welcome back” page can be displayed on the page associated with the invoice link, such as welcome back page 900. The welcome back page 900 can inform the invoicee of the total amount of their credit line and how much credit the invoicee has already used (and hence owes the cash provider). The invoicee can set up another payment to the invoicer by filling in some fields and clicking “submit” which will initiate an electronic funds transfer of the entered amount (e.g., $5,000 in FIG. 9) to the invoicer (e.g., “Diaz foods”).

In a further embodiment, an invoice sent from an invoicer to an invoicee can be paid by emailing the invoice to the cash provider. For example, when the invoicee received an invoice from the invoicer, the invoicee can email the invoice to the cash provider. The cash provider can then automatically pay the invoice on the invoicee's behalf utilizing the invoicee's credit line. In this way, the invoicee can have their bills paid easily and promptly. Note that this embodiment requires that the invoicee already have a credit line set up with the cash provider. If the invoicee attempts to use this method and such credit line has not already been set up, then the cash provider can provide the invoicee a credit application (such as that illustrated in FIG. 7) so the invoicee can complete and submit the credit application to the cash provider.

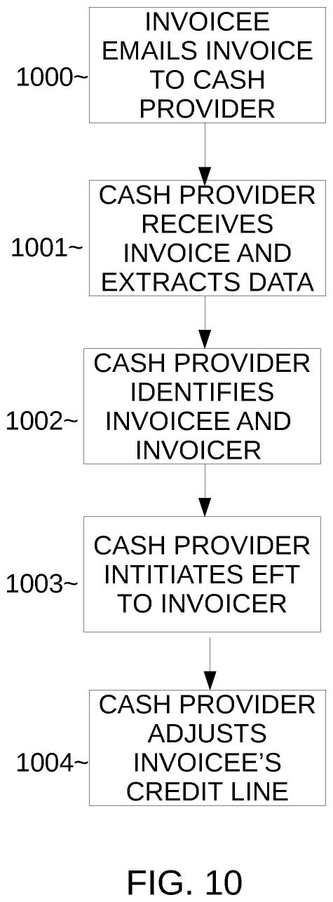

FIG. 10 is a block diagram illustrating an example of computer hardware to implement a digital computer, according to an embodiment.

The method begins with operation 1000, in which the invoicee has already received an invoice from an invoicer. The invoice is in electronic form (e.g., PDF, although other formats can be used as well). The invoicee emails the invoice to the cash provider (e.g., by sending an email (with the invoice as an attachment) directly to an email address associated with the cash provider, or by forwarding an email received from the invoicer with the invoice as an attachment to the cash provider).

From operation 1000, the method proceeds to operation 1001, in which the cash provider receives the invoice and extracts the data from the invoice. This means that all of the fields in the invoice can be automatically determined along with the values for those fields. This can be done by utilizing optical character recognition (OCR) to recognize the different entries on the invoice.

From operation 1001, the method proceeds to operation 1002, wherein the fields of all of the extracted data are identified. For example, in an invoice (such as that illustrated in FIG. 6), the cash provider can automatically determine: the name of the invoicer, the name of the invoicee, the total amount of the invoice, the date the invoice was generated, the date the invoice is due, the invoice number, the goods/services in which the invoice is billing for, etc. The values can be discerned by utilizing things such as the location on the invoice, the characters in the value (for example, if a ‘$’ is used before a number it is assumed that this represents a dollar amount). Individual dollar amounts are all identified and as a check, all of the dollar amounts but for the largest one should total the largest dollar amount. In this manner, the automatically determined total amount due for the invoice can be verified automatically. Utilizing the receiving address, the cash provider would know the identity of the invoicee (e.g., “Taco Town”) so the portion of the invoice that indicates the invoicee can be associated with the invoicee. Typically, the invoicer name is shown on the upper left of an invoice in larger font, so the OCR can use a weighting algorithm to automatically identify the best candidate for what the name of the invoicer is. The cash provider would also have a database of companies that it can make payment to on behalf of an invoicee. If the determined invoicer is on the list of companies that the cash provider can make payment to, this also serves as a confirmation that the invoicer has been identified correctly. This operation can also be done manually, or alternatively a human can manually confirm the electronically identified values for each field.

From operation 1002, the method proceeds to operation 1003, wherein the cash provider automatically initiates an electronic funds transfer from a bank account associated with the bank account to the invoicer on behalf of the invoicee. The amount transferred electronically would match the amount of the invoice. In the electronic funds transfer, there would also be data (fields) transmitted electronically such as a “miscellaneous text” field that the recipient (invoicer) would see. This field would include the invoice number as well as the name of the invoicee, so that when the invoicer receives the funds electronically from the cash provider the invoicer can match them up to the proper invoice and credit the invoicee with the payment.

From operation 1003, the method proceeds to operation 1004, wherein the cash provider will reduce the invoicee's available credit to coincide with the amount of the invoice which was paid to the invoicer. So if the invoicee's available credit is $5,000 (not to be confused with the total credit line which is the maximum amount of credit that the cash provider will extend to the invoicee), then after paying an invoice for $1,000 to the invoicee the cash provider will reduce the invoicee's available credit to $4,000. Of course, all cash that the cash provider has advanced (loaned) to the invoicee has to be paid back by the invoicee to the cash provider at an interest rate so that the cash provider would make a profit. In addition, the cash provider would also provide a notice (sent via email and/or in the physical mail) notifying the invoicee that the payment has been made (including the party (invoicer) the money was paid to, the date, the amount, the memo (miscellaneous text) on the electronic transfer, etc.) The cash provider may also provide such a notice to the invoicer via email and/or physical mail notifying them that the cash provider has made the payment (including the amount paid, the invoicee, date paid, the memo (miscellaneous text), etc.) on behalf of the invoicee so that the invoicer would properly credit the payment to the invoice.

In a further embodiment, invoices can be forwarded (e.g., emailed or mailed physically) to the cash provider, even where the invoicee on the invoice does not have an account (e.g., a credit line) with the cash provider. The cash provider can then provide the invoicee with a credit application in order for the invoicee to apply for a credit line with the cash provider. The cash provider can extract data from the invoice to automatically fill in fields on the credit line application, thereby making it easier for the invoicee to fill out the application.

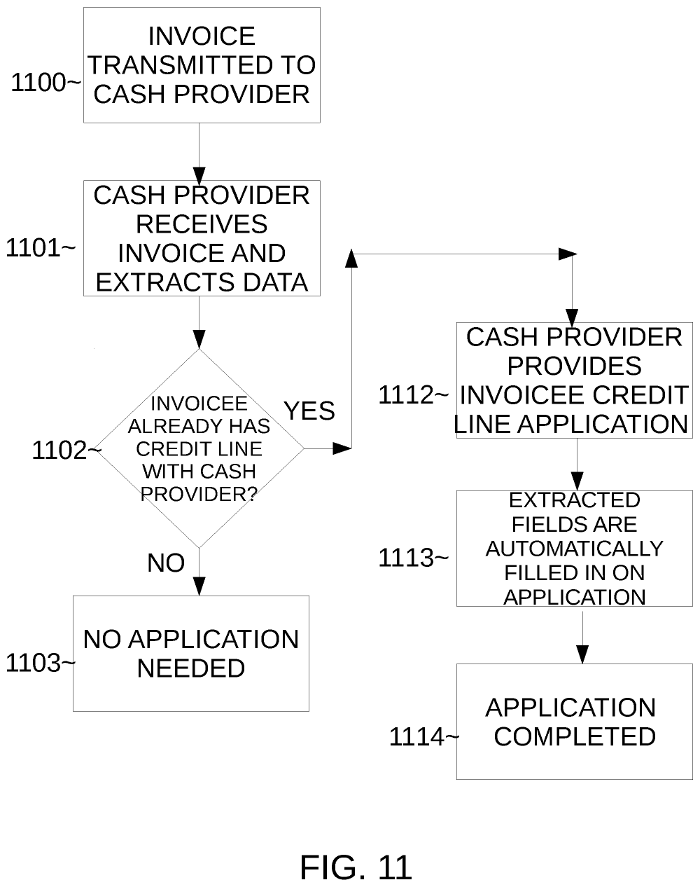

FIG. 11 is a flowchart illustrating an exemplary method of automatically filling in fields for a credit application, according to an embodiment.

The method can begin with operation 1100, wherein an invoice is transmitted to a cash provider. This can be done by any party (the invoicee or the invoicer) emailing (or mailing) the invoice to the cash provider (i.e., using a special email address for this purpose). Alternatively, the invoicer can email the invoice to the invoicee and the invoice can also be CCed (copied) or subsequently emailed to the cash provider, which would also initiate the method described and illustrated with regard to FIG. 11. The amount of the loan applied for could be equal to the amount invoiced, or it can be another amount (e.g., a greater amount so that the invoicee would have additional credit remaining to pay other invoices).

From operation 1100, the method proceeds to operation 1101, in which the cash provider receives the invoice and electronically and automatically extracts the data from the invoice. This can be done as described with regard to operations 1001 to 1002 of FIG. 10.

From operation 1101, the method proceeds to operation 1102, which determines whether the invoicee already has a credit line with the cash provider. The name of the invoicee is determined in operation 1101 (by extracting it from the invoice) and then a database maintained by the cash provider can be searched to determine whether the invoicee already has a credit line with the cash provider. If the invoicee already has a credit line with the cash provider, then the method proceeds to operation 1103, in which no credit line application is needed. In this instance, the amount invoiced can automatically be deducted from the invoicee's already existing credit line (assuming there is credit remaining). The invoicee can be (optionally) prompted to confirm that the invoice is to be paid from the credit line before the payment is automatically initiated. Of course, the invoicee can still choose to pay via other means if the invoicee so chooses. In this manner, the invoicee who already has an existing credit line with the cash provider can instantly have the invoice paid via their existing credit line with the cash provider.

If in operation 1102, it is determined that the invoicee does not already have a credit line account with the cash provider, then the method proceeds to operation 1112 in which the cash provider provides the invoicee (typically via an online web form) a credit line application (for example see FIG. 7).

From operation 1112, the method proceeds to operation 1113, in which the fields that were extracted in operation 1101 are automatically populated into the credit line application. This saves the invoicee the trouble of having to fill in this information into the application. This may result in a higher application completion rate. All fields that were not extracted from the invoice in operation 1101 (either they were not present on the invoice or were not discernable by the automated system) will not be automatically filled in and the invoicee will have to manually enter these fields. For example, the annual income of the invoicee is a field that would not be on an invoice and thus the cash provider would have no way of knowing this information, thus this field would have to be entered manually by the invoicee.

From operation 1113, the method proceeds to operation 1114, in which the application is completed and transmitted to the cash provider for processing. The processing comprises evaluating all of the fields in the application, retrieving further information about the invoicee from one or more databases on the internet, determining a score based on this information. If the score meets predefined criteria, then the invoicee is approved for the credit line, otherwise the invoicee would be declined for the credit line. See FIG. 4, operation 404, for more information on how a credit line application is evaluated and a decision is made.

Note that the embodiment involving the automated data extraction and form population (operations 1101, 1112, 1113) can be applied in other contexts as well. Any party (either the invoicer or the invoicer) can forward any invoice to the cash provider in order for the cash provider to initiate the automatic data extraction from the invoice to automatically populate a credit application. For example, if the invoicer feels that it would benefit if the invoicee would pay invoices more promptly, then the invoicer may wish to forward an invoice (or copy) to the cash provider for this purpose (using a special email address associated with the cash provider) to encourage the invoicee to sign up with the cash provider for the purpose of paying invoices. In addition to pre-populating fields in a credit application, the data extracted from an invoice can be used to pre-populate fields for other applications as well, such as an entry into an accounting system (so an invoicee can have the data from an invoice automatically entered into their accounting system), etc.

Note that the general paradigm described herein is enabling the invoicee to pay an invoice utilizing a credit line extended by the cash provider. In another embodiment, the invoicer can utilize a credit line in order to have their invoices paid (or in other words, receive cash which can serve as bridge financing until the invoice is actually paid by the invoicee) while waiting for the invoicee to actually pay the invoice. For example, if invoicer invoices invoicee for $100, the invoicer can utilize a credit line and have that invoice paid by the cash provider (an EFT for $100 will be transferred from the cash provider's bank account to the invoicer's bank account). The invoicer now will be responsible for paying the advanced amount ($100) plus any interest associated with the advance. In this manner, the invoicer can have all of their invoices paid (or receive loans while waiting for those invoices to be paid) promptly while waiting for the invoicee to actually pay the invoices. In exchange for the immediate payment by the cash provider, the invoicer would be responsible for paying any fees and interest agreed upon with the cash provider for providing this service. All of the embodiments described herein can be applied in this manner so that it is the invoicer who has applied for, and utilizes a line of credit from the cash provider which pays invoices that the invoicer has sent.

In an embodiment, if a loan application isn't automatically initiated, a widget or button can be placed on a page that the invoicee can visit. The page can be linked to via an email to the invoicee, the URL of the page can be pasted on the invoice, the page can also be a payment system page in which the invoicee uses to make payments. The invoicee can simply activate a widget or press (i.e., click) a button on the page which would initiate a new loan application (as described and illustrated in FIG. 11) which (if approved) can be used by the invoicee to pay the invoice.

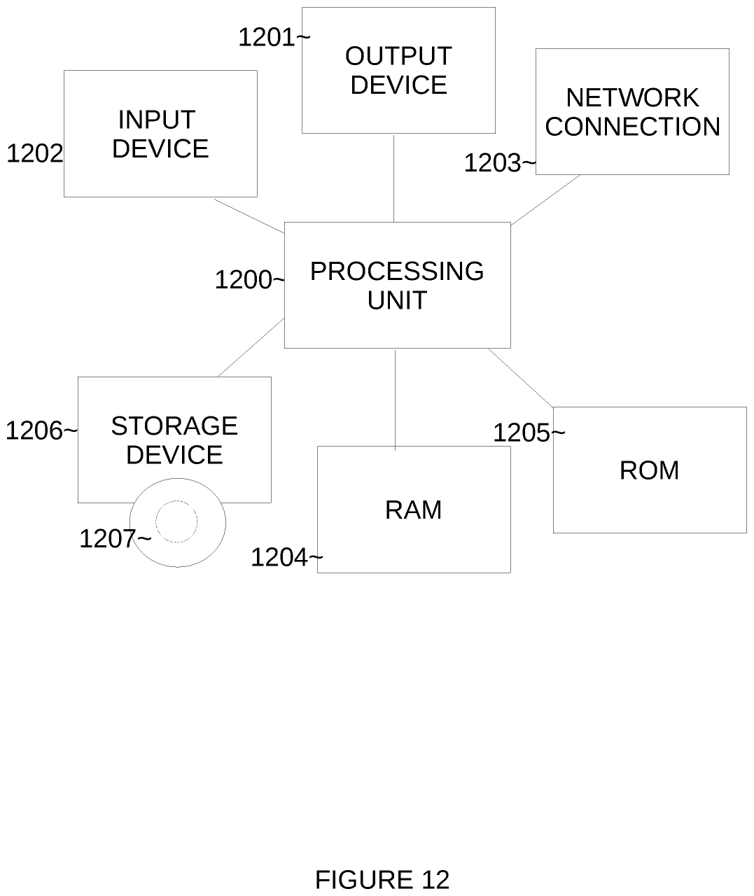

FIG. 12 is a block diagram illustrating an example of computer hardware which can be used to implement any computer utilized herein, according to an embodiment. The computer can also be any computing device, such as a cellular phone, tablet, server, database, personal computer, etc.

A processing unit 2500 (such as a microprocessor and any associated components) is connected to an output device 2501 (such as an LCD monitor, touch screen, CRT, etc.) which is used to display to the player any aspect/output/state of the method, and an input device 2502 (e.g., buttons, a touch screen, a keyboard, mouse, etc.) which can be used to input from the player any decision/input made by the player. All methods described herein can be performed by the processing unit 2500 by loading and executing respective instructions. Multiple such processing units can also work in collaboration with each other (in a same or different physical location). The processing unit 2500 can also be connected to a network connection 2503, which can connect the processing unit 2500 to a computer communications network such as the Internet, a LAN, WAN, etc. The processing unit 2500 is also connected to a RAM 2504 and a ROM 2505. The processing unit 2500 is also connected to a storage device 2506 which can be a disk drive, DVD-drive, CD-ROM drive, flash memory, etc. A non-transitory computer readable storage medium 2507 (e.g., hard disk, CD-ROM, etc.), can store a program which can control the electronic device to perform any of the methods described herein and can be read by the storage device 2506. A program (e.g., an application or “app”) can be executed by the processing unit 2500 in order to perform any of the methods/embodiments described herein. Such application can be downloaded from the internet by the processing unit 2500 via an online store (e.g., “app store” or “play store”). Any computer (e.g. the cash provider server, etc.) described herein can be utilized to implement the methods described herein, working individually or in conjunction with other computers.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

Any description of a component or embodiment herein also includes hardware, software, and configurations which already exist in the prior art and may be necessary to the operation of such component(s) or embodiment(s).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

Therefore, the following is claimed:

1. A system, comprising:
a computing device comprising a processor and a memory; and
machine-readable instructions stored in the memory that, when executed by the processor, cause the computing device to at least:
send an invoice to an invoicee device of an invoicee, the invoice comprising at least a link;
receive a request from the invoicee device, the request being directed to the link;
send an invoice payment detail web page to the invoicee device, the invoice payment detail web page comprising at least an amount input field to capture an invoice payment amount;
receive, from the invoicee device, an invoice payment detail response comprising at least the invoice payment amount; and
initiate a payment from a provider account to an invoicer account, the provider account being held by a provider and the invoicer account being held by the invoicer.

2. The system of claim 1, wherein the machine-readable instructions further cause the computing device to at least generate the link, the link being unique to the invoice.

3. The system of claim 1, wherein the machine-readable instructions further cause the computing device to at least generate the link, the link being unique to the invoicee associated with the invoicee device.

4. The system of claim 1, wherein the machine-readable instructions further cause the computing device to at least:
determine, in response to receiving the request from the invoicee device, that the invoicee does not have an account;
receive an account creation request, the account creation request includes at least at least bank account information of an invoicee and an identity of the invoicee; and
create, in response to determining that the invoicee is approved for a line of credit, the account based at least in part on the account creation request.

5. The system of claim 4, wherein the machine-readable instructions further cause the computing device to at least send, to the invoicee device, an account creation web page, the account creation web page having form fields filled with information extracted from the invoice.

6. The system of claim 1, wherein the invoice payment detail web page further comprises a plurality of payment term options, each payment term option comprising at least an interest rate and a payment time period.

7. The system of claim 1, wherein the payment from the provider account to the invoicer account is initiated in response to receive the invoice from an invoicer device.

8. A method, comprising:
sending an invoice to an invoicee device of an invoicee, the invoice comprising at least a link;
receiving a request from the invoicee device, the request being directed to the link;
sending an invoice payment detail web page to the invoicee device, the invoice payment detail web page comprising at least an amount input field to capture an invoice payment amount;
receiving, from the invoicee device, an invoice payment detail response comprising at least the invoice payment amount; and
initiating a payment from a provider account to an invoicer account, the provider account being held by a provider and the invoicer account being held by the invoicer.

9. The method of claim 8, further comprising generating the link, the link being unique to the invoice.

10. The method of claim 8, further comprising generating the link, the link being unique to the invoicee associated with the invoicee device.

11. The method of claim 8, further comprising:
determining, in response to receiving the request from the invoicee device, that the invoicee does not have an account;
receiving an account creation request, the account creation request includes at least at least bank account information of an invoicee and an identity of the invoicee; and
creating, in response to determining that the invoicee is approved for a line of credit, the account based at least in part on the account creation request.

12. The method of claim 11, further comprising sending, to the invoicee device, an account creation web page, the account creation web page having form fields filled with information extracted from the invoice.

13. The method of claim 8, wherein the invoice payment detail web page further comprises a plurality of payment term options, each payment term option comprising at least an interest rate and a payment time period.

14. The method of claim 8, wherein the payment from the provider account to the invoicer account is initiated in response to receive the invoice from an invoicer device.

15. A non-transitory, computer-readable medium, comprising machine-readable instructions that, when executed by a processor of a computing device, cause the computing device to at least:
send an invoice to an invoicee device of an invoicee, the invoice comprising at least a link;
receive a request from the invoicee device, the request being directed to the link;
send an invoice payment detail web page to the invoicee device, the invoice payment detail web page comprising at least an amount input field to capture an invoice payment amount;
receive, from the invoicee device, an invoice payment detail response comprising at least the invoice payment amount; and
initiate a payment from a provider account to an invoicer account, the provider account being held by a provider and the invoicer account being held by the invoicer.

16. The non-transitory, computer-readable medium of claim 15, wherein the machine-readable instructions further cause the computing device to at least generate the link, the link being unique to the invoice.

17. The non-transitory, computer-readable medium of claim 15, wherein the machine-readable instructions further cause the computing device to at least generate the link, the link being unique to the invoicee associated with the invoicee device.

18. The non-transitory, computer-readable medium of claim 15, wherein the machine-readable instructions further cause the computing device to at least:
determine, in response to receiving the request from the invoicee device, that the invoicee does not have an account;
receive an account creation request, the account creation request includes at least at least bank account information of an invoicee and an identity of the invoicee; and
create, in response to determining that the invoicee is approved for a line of credit, the account based at least in part on the account creation request.

19. The non-transitory, computer-readable medium of claim 15, wherein the invoice payment detail web page further comprises a plurality of payment term options, each payment term option comprising at least an interest rate and a payment time period.

20. The non-transitory, computer-readable medium of claim 15, wherein the payment from the provider account to the invoicer account is initiated in response to receive the invoice from an invoicer device.
